(19) United States
(12) Patent Application Publication
(10) Pub. No.: US 2008/0055038 A1
(43) Pub. Date: Mar. 6, 2008

(54) THERMAL SWITCH STRIKE PIN

(75) Inventors: Byron G. Scott, Arlington, WA (US); George D. Davis, Bellevue, WA (US); John F. Ehret, Sammamish, WA (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/469,382

(22) Filed: Aug. 31, 2006

(51) Int. Cl. H01H 37/74

(52) U.S. Cl. 337/343

(57) ABSTRACT

A striker pin in a thermal switch configured as a mechanical link between a bimetallic disk and an armature spring. The striker pin includes a pin of molded ceramic material. The pin has a generally cylindrical shape, a first axial end, and a second axial end. The first axial end is fastenable in fixed relation to an armature spring. A metallic film is fused to the second axial end. A metallic/synthetic deposit is fused to the metallic film such that the metallic/synthetic deposit substantially covers the second axial end.

### BACKGROUND OF THE INVENTION

Thermostatic switches (thermal switches) are engineered for use in high reliability applications such as Space Science Satellites, Defense Satellites, Commercial Satellites, Manned Space Flight Programs and High-Value Terrestrial Applications. Materials constituting thermal switches (referred to hereafter as “switches”) are developed and fabricated to have long life (20+ years) and high reliability while operating under extreme conditions even where service of the switch is impracticable such as an application within Space and Launch Vehicles.

The switches are bimetallic snap action type. A bimetallic disk actuates by detecting temperature change above or below an operational set point. The disk is made of two dissimilar metals: a low expansion side and a high expansion side. These metals are repeatedly rolled together and annealed to create a high state of reduction. The materials are then punched into disks. The result is a precision temperature switch.

The bimetallic disk does not have electrical contacts mounted on it. An armature spring is parallel to the bimetallic disk and urges a set of electrical contacts together to close a switch. A non-conductive electro-mechanical link between the bimetallic disk and the armature spring conveys the force created by triggering the disk to the armature spring thereby opening the contacts. That mechanical link is called a striker pin. Conventionally, the striker pin is mounted on the armature spring and bears against the triggered disk. Triggering the bimetallic disk causes it to snap from a concave to a convex shape striking the striker pin. The pin presses, in turn, the armature to the open contact position.

Alumina (Al₂O₃), nickel, copper, or some other metal or metal alloy are is a preferred material for the striker pin. Its high free energy of formation makes alumina chemically stable and refractory, and hence it finds uses in containment of aggressive and high temperature environments. The high hardness of alumina imparts wear and abrasion resistance. The high volume resistivity and dielectric strength make alumina an excellent electrical insulator. These qualities make it a suitable material for the high temperature and numerous cycles of the switch. Unfortunately, alumina is an abrasive material. The end of the striker pin bears against the bimetallic disk and thus often wears or cuts into the surface of the disk over repeated duty cycles. Cycling of the switch and the attendant cutting action of the ceramic on the disk at the disk-to-pin interface affect temperature setpoint and generate metallic fragments that might interfere with the operation of the switch.

To stem the wear on the bimetallic disk, a metallic coating is deposited at the point where the striker pin bears against the bimetallic disk. The purpose of the coating is to substitute the surface of a metal such as nickel, copper or a metal alloy for the abrasive surface of the alumina ceramic. The current metal caps are very difficult to place accurately. Unfortunately the placement of the caps is not easily reproducible causing variance in the critical length dimension of the resulting pin. Slightly skewed caps vary the overall length. Epoxy resinous adhesives tend to outgas and degrade in the extreme harsh heated environments the thermal switch is design to operate in.

There is an unmet need in the art for a striker pin with an affixed bearing surface to prevent disk-to-pin wear.

### SUMMARY OF THE INVENTION

The present invention is a striker pin in a thermal switch configured as a mechanical link between a bimetallic disk and an armature spring. The striker pin includes a pin of molded ceramic material. The pin has a generally cylindrical shape, a first axial end, and a second axial end. The first axial end is fastenable in fixed relation to an armature spring. A metallizing film is fused to the second axial end. A metallic/synthetic deposit is fused to the metallizing film such that the metallic/synthetic deposit substantially covers the second axial end.

In accordance with further aspects of the invention, the metallic/synthetic deposit with its attendant lubricity greatly reduces the wear of the bimetallic disk over that caused by the bare alumina pin.

As will be readily appreciated from the foregoing summary, the invention provides a rugged, smooth, lubricious surface for a pin bearing on a bimetallic disk is also uniform and reduced mass.

### BRIEF DESCRIPTION OF THE DRAWINGS

The preferred and alternative embodiments of the present invention are described in detail below with reference to the following drawings:

FIG. 1 is a is a cross-section of a thermal switch showing a striker pin in place; and

FIG. 2 is a flowchart of a method to produce the striker pin.

### DETAILED DESCRIPTION OF THE PREFERRED EMBODIMENT

By way of overview, a striker pin in a thermal switch configured as a mechanical link between a bimetallic disk and an armature spring is provided. The striker pin includes a pin of molded ceramic material. The pin has a generally cylindrical shape, a first axial end, and a second axial end. The first axial end is fastenable in fixed relation to an armature spring. A metallizing film is fused to the second axial end. A metallic/synthetic deposit is fused to the metallizing film such that the metallic deposit substantially covers the second axial end.

The thermal switch is designed for use in high reliability applications such as Space Science Satellites, Defense Satellites, Commercial Satellites, Manned Space Flight Programs and High-Value Terrestrial Applications. Because of the operating environment and the extremely high cost of repair (requiring a separate space flight for replacement) the switches are developed and fabricated to have long life (20+ years) and high reliability while operating under extreme conditions. The switches are bimetallic snap action type relying upon the designed thermostatic characteristics of a bimetallic disk.

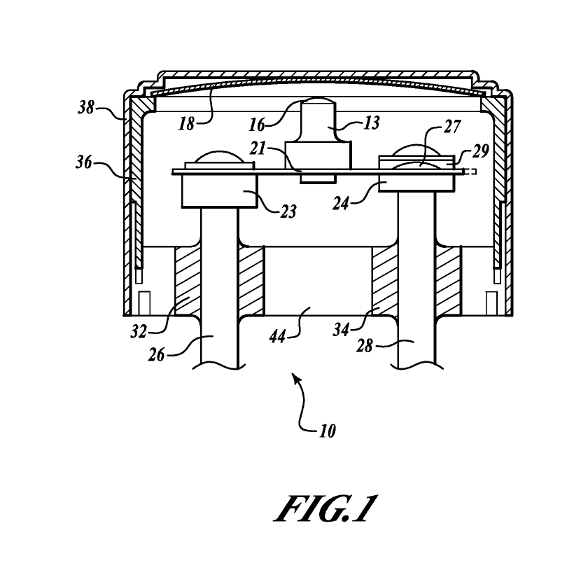

FIG. 1 is a cut-away drawing of the thermal switch 10. A case 38 encloses the components of the switch 10. A bimetallic disk 18 is loosely held inside of a cavity defined by the case 38 and a spacer cylinder 36 coaxially fitted within the case 38. A header plate 44 is perforated suitably to receive an external terminal post 26 and an external terminal post 28, and are placed in fixed relation within the case 38 and spacer cylinder 36.

A hermetic glass seal 32 holds the external terminal post 26 fixed in one of two perforations to the header plate 44, while a hermetic glass seal 34 holds the external terminal past 28 fixedly in the other perforation. An armature spring is riveted to the top of the terminal post 23. A stationary contact is riveted to the top of the terminal post 24. A striker pin 13 is affixed to the armature spring 21 and bearing against the bimetallic disk 18 during one operating state (contacts open). A metallic/synthetic deposit 16 is affixed at an end of the striker pin 13.

The bimetallic disk 18 actuates by detecting temperature change above or below its operational set points. It actuates by deforming convexly. In doing so the bimetallic disk 18 presses against the striker pin forcing the armature spring 21 to open or to close a pair of electrical contacts (29 and 27) depending upon the designed cycle of the switch 10.

The striker pin 13 includes a ceramic material with a bonded lubricious metallic/synthetic deposit 16, such as an autocatalytic nickel matrix that includes second phase particles that impart additional advantageous properties. An example of the second phase particles include Polytetrafluoroethylene (PTFE or Teflon®), such as that produced by Coating Technologies Inc. of Phoenix, Ariz. under the brand name NP3. Fusion of the ceramic material and the metallic/synthetic deposit 16 is done by a process of metallizing a film layer, such as a nickel film or other metals as described below, and then plating the surface to achieve strong mechanical bonding.

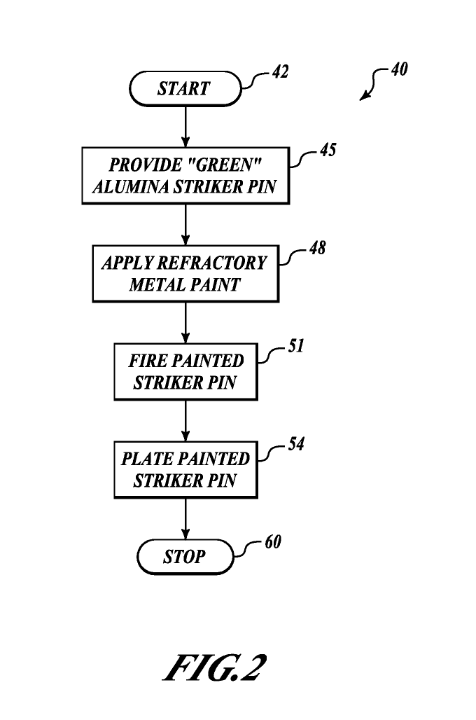

FIG. 2 is a flowchart of a process 40 used to fuse the metallic/synthetic deposit 16 to the striker pin 13. Starting at a terminus block 42, a “green” ceramic pin is provided at a block 45. Green ceramic is an unfired ceramic that has not achieved its vitrification. The green ceramic is solid and machineable and does not have the strength nor the relative smoothness of fired ceramic.

At a block 48, a refractory metal paint, preferable including molybdenum or a similar substance, is applied at the intended site of the metallic/synthetic deposit 16 on the green ceramic pin. In one embodiment, the refractory metal paint includes a small amount of manganese (around 10% is generally suitable). The refractory metal paint is generally applied by either brushing or screen printing onto the ceramic surface to be metallized to form a metallic layer.

At a block 51, the pin with the refractory metal paint is fired (heated). Firing serves two purposes. First, firing cures the ceramic pin bringing it to its vitreous state. Firing also sinters a boundary between the green ceramic and the refractory metal paint causing the metal paint to bond to the ceramic pin. As the ceramic enters the glass phase of firing, the ceramic is drawn into the interstices of the refractory metal paint, i.e., a molybdenum layer of the paint. The added manganese then has two effects. First, upon heating during the sintering, the manganese is oxidized to form manganese oxide, which, at temperature, enhances the permeation of the ceramic in the glass phase into the molybdenum layer. Second, the manganese penetrates down ceramic grain boundaries of the pin and changes the properties of the ceramic in the glass phase. These two changes decrease both the thermal expansion mismatch between the molybdenum layer and the ceramic, and alter the glass transition temperature of the ceramic pin. The results may be enhanced where firing occurs under a greater atmospheric pressure resulting in what is known as “densification,” i.e. the further migration of metals in to the boundary region. As a result, there is less residual stress at the metallized interface, which leads to a stronger bond than had previously been achieved with the refractory metals alone.

Once a defect free molybdenum-manganese layer has been successfully applied and fired, the resulting pin is plated with a thin layer of a suitable metallic and synthetic combination. The immediate plating with metallic/synthetic material prevents oxidation of the Mo—Mn layer. Usually, the metallic/synthetic material is deposited either by electroplating, electroless plating, by the reduction in hydrogen of nickel oxide paint or by some other fusing process. Upon plating, the pin is suitable for use as the striker pin 13.

In another embodiment the refractory metal paint or film includes Nickel.

While the preferred embodiment of the invention has been illustrated and described, as noted above, many changes can be made without departing from the spirit and scope of the invention. Accordingly, the scope of the invention is not limited by the disclosure of the preferred embodiment.

1. A thermal switch comprising:
an armature spring;
a pin of molded ceramic material having a first axial end and a second axial end, the first axial end is fastenable in fixed relation to the armature spring;
a metallic film is fused to the second axial end; and
synthetic deposit is fused onto the metallic film such that the synthetic deposit is substantially covering the second axial end.

2. The thermal switch of claim 1, wherein the metallic film includes molybdenum.

3. The thermal switch of claim 2, wherein the metallic film further includes manganese.

4. The thermal switch of claim 3, wherein the metallic film further includes manganese oxide.

5. The thermal switch of claim 1, wherein the metallic film includes nickel.

6. The thermal switch of claim 7, wherein the synthetic deposit includes nickel.

7. The thermal switch of claim 1, wherein the synthetic deposit includes Polytetrafluoroethylene (PTFE).

8. The thermal switch of claim 1, wherein the pin has a generally cylindrical shape.

9. A striker pin in a thermal switch configured as a mechanical link between a bimetallic disk and an armature spring, the striker pin comprising:
a molded ceramic component having a first axial end and a second axial end, the first axial end is fastenable in fixed relation to the armature spring;
a metallic film fused to the second axial end; and
a synthetic deposit fused onto the metallic film such that the synthetic deposit is substantially covering the second axial end.

10. The striker pin of claim 9, wherein the metallic film includes molybdenum.

11. The striker pin of claim 10, wherein the metallic film further includes manganese.

12. The striker pin of claim 11, wherein the metallic film further includes manganese oxide.

13. The striker pin of claim 9, wherein the metallic film includes nickel.

14. The striker pin of claim 15, wherein the metallic/synthetic deposit includes nickel.

15. The striker pin of claim 9, wherein the metallic/synthetic deposit includes Polytetrafluoroethylene (PTFE).

16. The striker pin of claim 9, wherein the pin has a generally cylindrical shape.
